(19) United States
(12) Patent Application Publication
(10) Pub. No.: US 2006/0280066 A1
(43) Pub. Date: Dec. 14, 2006

(54) Information storage medium, medium processing apparatus, and medium processing method

(76) Inventors: Keiichiro Yusu, Yokohama-shi (JP); Yasuhiro Satoh, Yokohama-shi (JP); Sumio Ashida, Yokohama-shi (JP); Naomasa Nakamura, Yokohama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/446,385

(22) Filed: Jun. 5, 2006

(30) Foreign Application Priority Data
Jun. 8, 2005 (JP) 2005-168342

(51) Int. Cl. G11B 7/00; G11B 3/70; G11B 7/26

(52) U.S. Cl. 369/44.38; 369/283; 369/288

(57) ABSTRACT

According to one embodiment, an information storage medium includes a light incident surface from which a recording/playback light beam enters, a reflecting layer which reflects the light beam entering from the light incident surface, a recording layer which is arranged between the light incident surface and the reflecting layer, and a playback signal emphasizing layer which is arranged between the recording layer and the reflecting layer, and used to emphasize a playback signal containing a reflectance change component generated by a recording mark formed on the recording layer.

### CROSS-REFERENCE TO RELATED APPLICATIONS

This application is based upon and claims the benefit of priority from Japanese Patent Application No. 2005-168342, filed Jun. 8, 2005, the entire contents of which are incorporated herein by reference.

### BACKGROUND

1. Field

One embodiment of the invention relates to a rewritable information storage medium, write-once information storage medium, and read-only information storage medium. Another embodiment of the invention relates to a medium processing apparatus and medium processing method for processing these information storage media.

2. Description of the Related Art

In Jpn. Pat. Appln. KOKAI Publication Nos. 2003-338077 and 2004-87073, a technique pertaining to an optical disc on which information can be recorded at high density using light is disclosed. In recent years, a phase change optical recording medium on which information can be rewritten any number of times, and a WO optical recording medium on which information can be recorded only once are mainly used.

A phase change recording medium includes a recording layer made of a material whose phase and reflectance change upon being irradiated with light. Upon being irradiated with high-power and short-pulse light, the phase change recording layer which contains Ge, Sb, Te, In, and Ag as principal components melts. The melted layer changes into amorphous phase upon cooling, thereby forming a recording mark. Upon irradiating this amorphous recording mark with low-power and long-pulse light, the amorphous recording mark is heated to a temperature equal to or higher than the crystallization temperature and then gradually cools down to crystallize and be erased. In a recording medium using a phase change recording layer, such operation is repeated to rewrite data. By detecting the difference between the reflectances of an amorphous recording mark portion and a crystalline space portion, data can be played back. Accordingly, the reflectance difference is determined based on a change in optical constant of the above-described material along with phase change. This currently used material system has been found as a result of many years of study, and is a material system which undergoes a large optical change along with phase change. However, along with further increase in recording density, the recording mark is expected to become smaller, and it may then become more difficult to detect the reflectance change of the above-described material system.

On the other hand, as WO optical recording mediums, an optical recording medium which includes a recording layer made of an inorganic material such as a chalcogenide element represented by a Te compound, and an optical recording medium which includes a recording layer made of a recording material obtained by dispersing a pigment such as a cyanine derivative, phthalocyanine derivative, porphyrin derivative, or metal porphyrin derivative in a solvent have been known. The former inorganic recording layer is formed by a film formation method represented by a dry process such as vacuum deposition or sputtering. The latter organic recording layer is formed by a wet process such as spin coating or an electrolytic method. In spin coating of these methods, the droplet of a solution prepared by dissolving an organic pigment in a solvent such as dichloromethane is dropped on a substrate, and the substrate is rotated to form a thin film thereon. Generally, spin coating has been recognized as a low-cost method. A present-generation WO optical disc using a red LD has been available as a CD-R and DVD-R in the market. All such WO optical discs include recording layers made of the above-described organic pigment, and are formed in a wet process at low manufacturing cost. Recording mechanisms of almost all WO optical disc including the recording layer made of the organic pigment involve local destruction of the recording layer. That is, light focused to have a diameter of 1 μm on the recording layer by an objective lens and absorbed in it is converted into heat to locally evaporate the pigment or transform a substance attached to the pigment. As a result, since light focused on this portion is scattered in playback, the reflectance decreases to be recognized as a recording mark. However, when the absorption ratio is too high for a light source wavelength, the pigment decomposes only by applying playback light, thereby losing the recorded data. To cope with this problem, the absorption ratio must be suppressed to a certain degree in order to avoid data destruction in playback, while a high absorption ratio for the light source wavelength is required in order to efficiently convert the absorbed light into heat. Hence, the WO optical disc such as the CD-R or DVD-R uses an organic pigment such as a cyanine pigment or phthalocyanine pigment having an absorption peak near the wavelength of 780 or 650 nm as a light source.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a sectional view showing a rewritable optical recording medium (information storage medium) according to a first embodiment of the invention;

FIG. 2 is a sectional view showing a WO optical recording medium (information storage medium) according to a second embodiment of the invention;

FIG. 3 is a sectional view showing a read-only optical recording medium (information storage medium) according to a third embodiment of the invention;

FIG. 4 is a sectional view showing a rewritable optical recording medium according to a fourth embodiment of the invention;

FIG. 5 is a graph for explaining changes in jitter and reflectance as a function of the irradiation power in the rewritable optical recording medium according to the fourth embodiment;

FIG. 6 is a sectional view showing a WO optical recording medium according to a fifth embodiment of the invention;

FIG. 7 is a graph for explaining changes in jitter and reflectance as a function of the irradiation power in the WO optical recording medium according to the fifth embodiment;

FIG. 8 is a sectional view showing a read-only optical recording medium according to a sixth embodiment of the invention;

FIG. 9 is a graph for explaining changes in jitter and reflectance as a function of the irradiation power in the read-only optical recording medium according to the sixth embodiment;

FIG. 10 is a graph for explaining the dependence of the normalized reflectance on the irradiation power in each optical recording medium according to a comparative example;

FIG. 11 is a graph for explaining the dependence of the normalized reflectance on the irradiation power in each optical recording medium according to the comparative example;

FIG. 12 is a table showing an example of an evaluation condition; and

FIG. 13 is a block diagram showing the schematic arrangement of an optical disc apparatus (medium processing apparatus) according to an embodiment of the invention.

### DETAILED DESCRIPTION

Various embodiments according to the invention will be described hereinafter with reference to the accompanying drawings. In general, according to one embodiment of the invention, an information storage medium includes a light incident surface from which a recording/playback light beam enters, a reflecting layer which reflects the light beam entering from the light incident surface, a recording layer which is arranged between the light incident surface and the reflecting layer, and a playback signal emphasizing layer which is arranged between the recording layer and the reflecting layer, and used to emphasize a playback signal containing a reflectance change component generated by a recording mark formed on the recording layer.

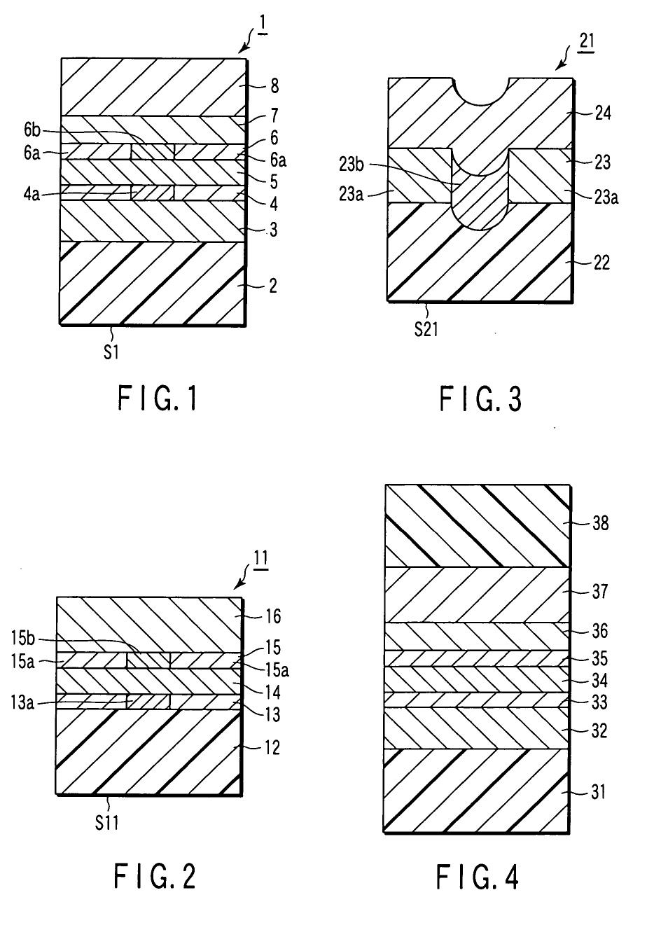

FIG. 1 is a sectional view showing a state wherein a rewritable optical recording medium (information storage medium) is formed on a substrate according to the first embodiment of the invention.

According to the first embodiment of the invention, a rewritable optical recording medium 1 comprises a light incident surface S1 from which a recording/playback light beam enters, a resin and/or glass substrate 2, an optical interference layer 3, a recording layer 4, an optical interference layer 5, a playback signal enhancement layer (playback signal emphasizing layer) 6, an optical interference layer 7, and a reflecting layer 8. As shown in FIG. 1, the recording layer 4 is sandwiched between the light incident surface S1 and the reflecting layer 8. The playback signal enhancement layer 6 is arranged between the recording layer 4 and the reflecting layer 8, and used to emphasize a playback signal containing a reflectance change component generated by a recording mark formed in the recording layer 4.

In the recording layer 4, an amorphous recording mark 4a is formed in a region irradiated with a pulse laser with the first laser power (e.g., 4 or 5 mW) and the second laser power (e.g., 10 mW) larger than the first laser power from the light incident surface S1. In the playback signal enhancement layer 6, upon being continuously irradiated with a pulse laser with the third laser power (e.g., 5 or 6 mW) larger than the first laser power and smaller than the second laser power from the light incident surface S1, a region 6a opposite to a non-recording mark region in the recording layer 4 changes (phase change), and the reflectance of the region 6a becomes different from that of a region 6b opposite to the region of the amorphous recording mark 4a in the recording layer 4. That is, the reflectances of the regions 6a and 6b become different from each other.

FIG. 1 shows an example of a High to Low (to be referred to as HtoL hereinafter) polarity. Note that each of the optical interference layers 3, 5, and 7 may include a plurality of layers in view of optical design or thermal design.

FIG. 2 is a sectional view showing a state wherein a WO optical recording medium (information storage medium) is formed on a substrate according to the second embodiment of the invention.

According to the second embodiment of the invention, a WO optical recording medium 11 comprises a light incident surface S11 from which a recording/playback light beam enters, a resin and/or glass substrate 12, a recording layer 13, an optical interference layer 14, a playback signal enhancement layer (playback signal emphasizing layer) 15, and a reflecting layer 16. As shown in FIG. 2, the recording layer 13 is inserted between the light incident surface S11 and the reflecting layer 16. The playback signal enhancement layer 15 is arranged between the recording layer 13 and the reflecting layer 16, and used to emphasize a playback signal containing a reflectance change component generated by a recording mark formed in the recording layer 13.

In the recording layer 13, a recording mark 13a is formed in a region irradiated with a pulse laser with the first laser power (e.g., 0.5 mW) and the second laser power (e.g., 10 mW) larger than the first laser power from the light incident surface S11. In the playback signal enhancement layer 15, upon being continuously irradiated with a pulse laser with the third laser power (e.g., 1 mW) larger than the first laser power and smaller than the second laser power from the light incident surface S11, a region 15a opposite to a non-recording mark region in the recording layer 13 changes (phase change), and the reflectance of the region 15a becomes different from that of a region 15b opposite to the region of the recording mark 13a in the recording layer 13. That is, the reflectances of the regions 15a and 15b become different from each other.

FIG. 2 shows an example of an HtoL polarity. Note that an optical interference layer may be inserted between the substrate 12 and recording layer 13, or the playback signal enhancement layer 15 and reflecting layer 16, as needed. The optical interference layer may also include a plurality of layers for the same reason as in the case of the above-described rewritable optical recording medium.

FIG. 3 is a sectional view showing a read-only optical disc (information storage medium) according to the third embodiment of the invention.

According to the third embodiment of the invention, a read-only optical disc 21 comprises a light incident surface S21 from which a playback light beam enters, a resin and/or glass substrate 22, a playback signal enhancement layer (playback signal emphasizing layer) 23, and a reflecting layer 24. As shown in FIG. 3, in the reflection layer 24, the reflectance of the incident light beam is changed by a preformed pit. The playback signal enhancement layer 23 is sandwiched between the light incident surface S21 and the reflecting layer 24, and used to emphasize a playback signal containing a reflectance change component generated by a pit.

In the playback signal enhancement layer 23, upon being continuously irradiated with a pulse laser with a predetermined laser power from the light incident surface S21, a region 23a opposite to a non-pit region changes, and the reflectance of the region 23a becomes different from that of a region 23b opposite to a pit region. That is, the reflectances of the regions 23a and 23b become different from each other.

Note that an optical interference layer may be inserted between the substrate 22 and playback signal enhancement layer 23, or the playback signal enhancement layer 23 and reflecting layer 24, as needed. The optical interference layer may also include a plurality of layers for the same reason as in the case of the above-described rewritable optical recording medium.

The fourth, fifth, and sixth embodiments will be described below to describe the invention in more detail.

The fourth embodiment will be described below.

As shown in FIG. 4, a 30-nm thick ZnS-SiO₂ layer was formed as an optical interference layer 32 (corresponding to the optical interference layer 3) by RF magnetron sputtering of 1 kw on a 0.6-mm thick polycarbonate (PC) substrate 31 having a groove with a track pitch of 0.62 μn and a depth of 70 nm. After that, a 10-nm thick Ge₂₂Sb₂₂Te₅₆ layer was formed as a recording layer 33 (corresponding to the recording layer 4) by RF magnetron sputtering of 0.2 kW. Subsequently, a 10-nm thick ZnS-SiO₂ layer was formed as an optical interference layer 34 (corresponding to the optical interference layer 5) by RF magnetron sputtering of 1 kw, and a 15-nm thick Ge₄₀Sb₈Te₅₂ layer was then formed as a playback signal enhancement layer 35 (corresponding to the playback signal enhancement layer 6) by RF magnetron sputtering of 0.2 kW. After that, a 40-nm thick ZnS-SiO₂ layer was formed as an optical interference layer 36 (corresponding to the optical interference layer 7) by RF magnetron sputtering of 1 kW, and a 50-nm Ag₉₈Pd₁Cu₁ layer was then formed as a reflecting layer 37 (corresponding to the reflecting layer 8) by DC magnetron sputtering of 1 kW. On the surface of the substrate stack on which the films were formed, a UV curing resin was applied, and a 0.6-mm thick dummy PC substrate 38 was bonded to complete a bonded rewritable optical disc.

A laser initialization apparatus was used to perform initial crystallization only for the recording layer 33 in the completely formed optical disc. At this time, the reflectance after initialization was 18%.

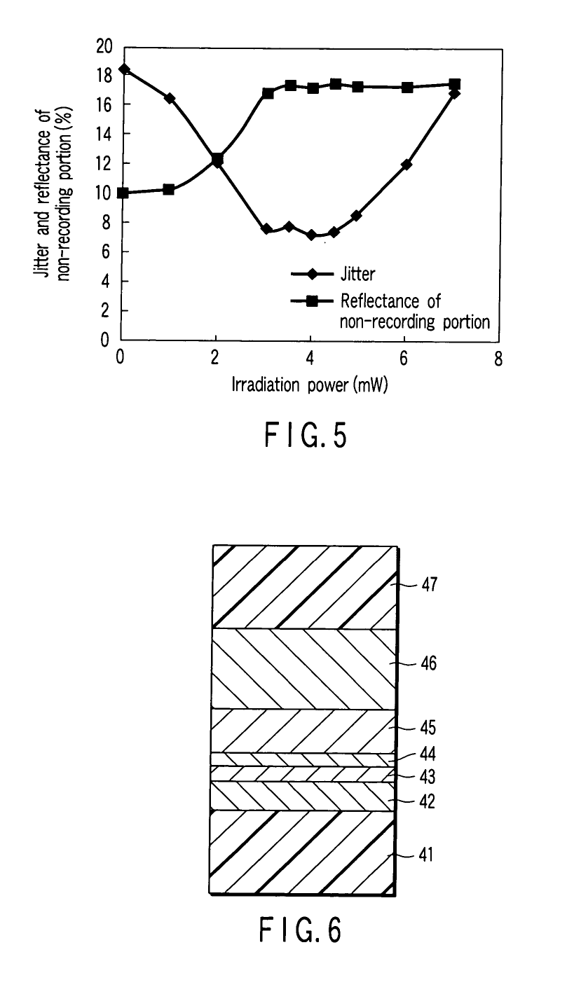

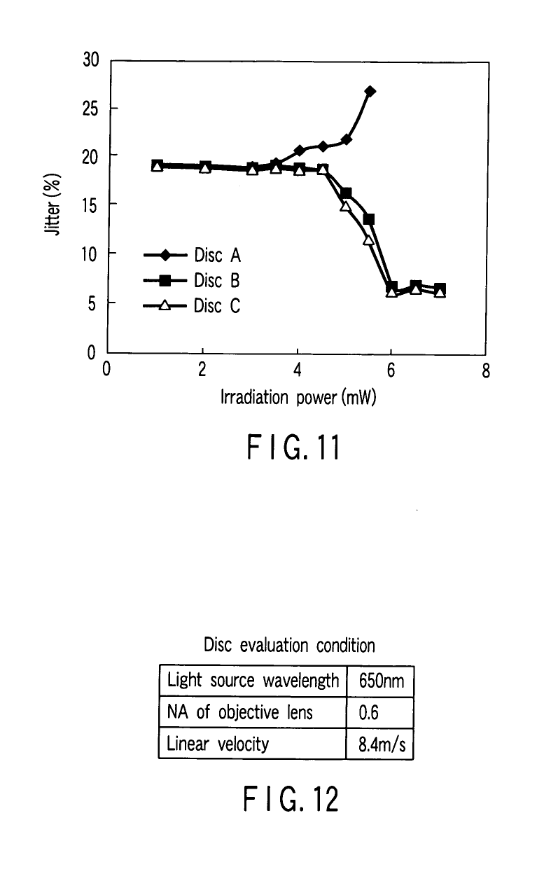

Under the evaluation condition shown in FIG. 12, random data was recorded on such rewritable optical disc with a recording power of 11 mW and an erasure power of 6 mW. After that, an acceleration test was performed under the conditions of a temperature of 85° C. and a relative humidity of 85%. After the acceleration test for 400 hrs, the jitter changed from 7.2% to 18.9% and the reflectance changed from 18% to 9.7%, and data could not be satisfactorily played back. FIG. 5 shows the reflectance and jitter change upon continuously irradiating this disc with light. When the irradiation power is equal to or higher than 3 mW, the jitter and reflectance start to improve. When the irradiation power is in the range of 3.0 to 4.5 mW, the jitter and reflectance return to the characteristics before deterioration. It is supposed that such playback signal recovery phenomenon is caused by selective crystallization of those portions of the playback signal enhancement layer 35 which correspond to a non-recording portion. It is also supposed that since the amorphous recording mark in the recording layer crystallizes, the jitter increases when the irradiation power is equal to or higher than 5.0 mW. Note that in the disc continuously irradiated with light before the acceleration test, the jitter was equal to or lower than 6%, and the reflectance of the non-recording portion was equal to or higher than 24%. In this case, data could be played back although the reflectance decreased after the acceleration test for 400 hrs.

The fifth embodiment will be described below.

As shown in FIG. 6, an 80-nm thick azo metal complex was applied by a spin coater on a 0.6-mm thick polycarbonate (PC) substrate 41 (corresponding to the substrate 12) having a groove with a track pitch of 0.74 μm and a depth of 170 nm to form a recording layer 42 (corresponding to the recording layer 13). Next, a 15-nm thick ZrO₂ layer was formed as an optical interference layer 43 (corresponding to the optical interference layer 14) by RF magnetron sputtering of 1 kW, and a 10-nm thick Ge₃₁Sb₁₄Te₅₅ layer was then formed as a playback signal enhancement layer 44 (corresponding to the playback signal enhancement layer 15) by RF magnetron sputtering of 0.2 kW. After that, a 50-nm thick ZrO₂ layer was formed as an optical interference layer 45 by RF magnetron sputtering of 1 kW, and a 100-nm Ag₉₉Mo₁ layer was then formed as a reflecting layer 46 (corresponding to the reflecting layer 16) by DC magnetron sputtering of 1 kW. On the surface of the substrate stack on which the films are formed, a UV curing resin was applied, and a 0.6-mm thick dummy PC substrate 47 was bonded to complete a bonded WO optical disc. At this time, the reflectance of the non-recording portion was 75%.

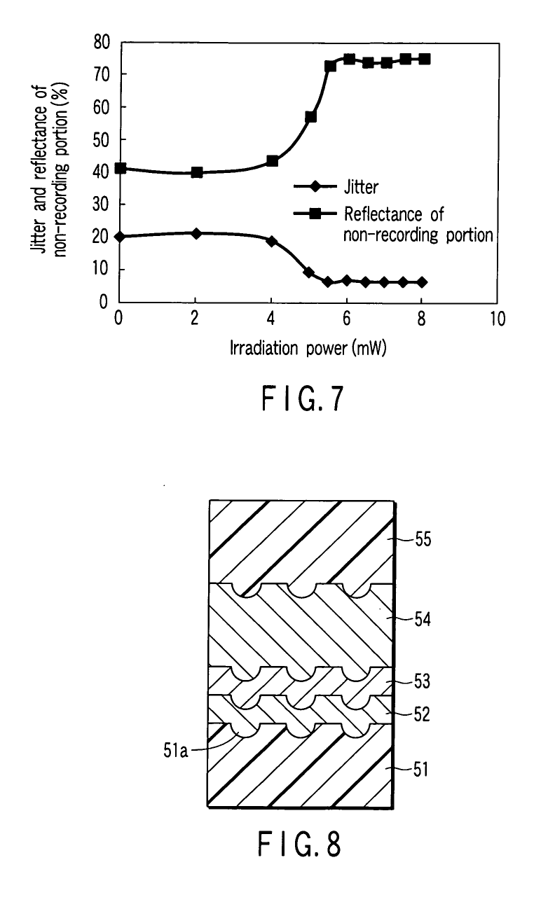

Under the evaluation condition shown in FIG. 12, random data was recorded on such WO optical disc with a recording power of 12.5 mW and a bottom power of 0.1 mW. After that, an acceleration test was performed under the conditions of a temperature of 85° C. and a relative humidity of 85%. After the acceleration test for 400 hrs, the jitter changed from 6.8% to 20.0% and the reflectance changed from 75% to 42%, and data could not be satisfactorily played back. FIG. 7 shows the reflectance and jitter change upon continuously irradiating this disc with light. When the irradiation power is equal to or higher than 5 mW, the jitter and reflectance start to improve. When the irradiation power is equal to or higher than 5.5 mW, the jitter and reflectance return to the characteristics before deterioration. It is supposed that such playback signal recovery phenomenon is caused by selectively crystallization of those portions of the playback signal enhancement layer which correspond to a non-recording portion. It is also supposed that since the recording mark in the recording layer optically changes by excessively heating the recording mark, the jitter slightly increases when the irradiation power is equal to or higher than 7.5 mW. Note that in the disc continuously irradiated with light before the acceleration test, the jitter was equal to or lower than 6%, and the reflectance of the non-recording portion was equal to or higher than 80%. In this case, data could be played back even after the acceleration test for 400 hrs.

The sixth embodiment will be described below.

As shown in FIG. 8, a 20-nm thick Ge₂₂Sb₂₂Te₅₆ layer was formed as a playback signal enhancement layer 52 (corresponding to the playback signal enhancement layer 23) by RF magnetron sputtering of 0.2 kW on a 0.6-mm thick polycarbonate (PC) substrate 51 (corresponding to the substrate 22) having an information pit with a pitch of 0.74 μm and a depth of 100 nm in a disc radial direction. After that, a 10-nm thick Al₂O₃ layer was formed as an optical interference layer 53 by RF magnetron sputtering of 1 kW, and a 50-nm thick Al₉₉Ti₁ layer was formed as a reflection layer 54 (corresponding to the reflection layer 24) by DC magmetron sputtering of 1 kW. On the surface of the substrate stack on which the films were formed, a UV curing resin was applied, and a 0.6-mm thick dummy PC substrate 55 was bonded to complete a bonded read-only optical disc. The reflectance of the non-pit region (i.e., mirror portion) was 78%.

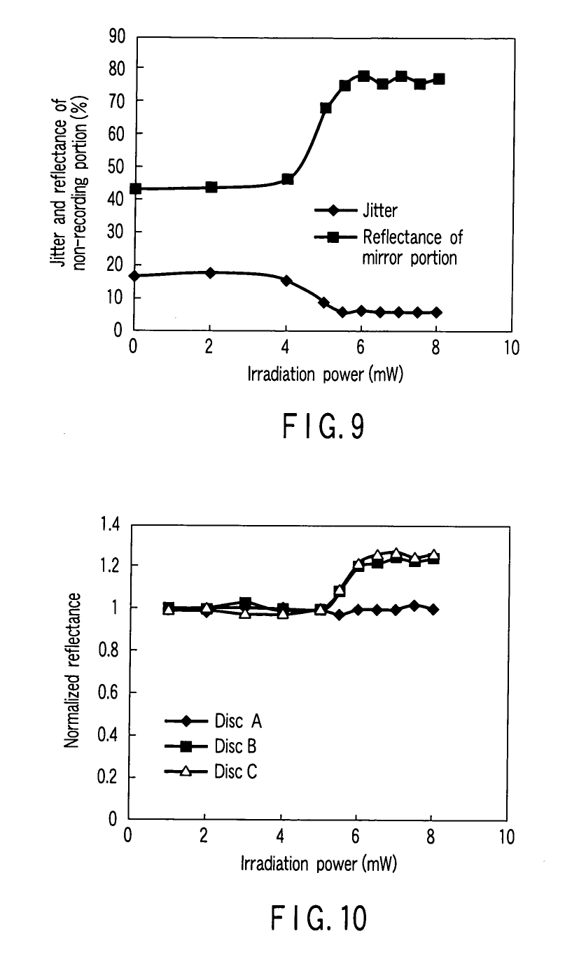

An acceleration test was performed for the disc stored in a thermostatic chamber at a temperature of 85° C. and a relative humidity of 85%. After the acceleration test for 400 hrs, the jitter changed from 6.0% to 17.0% and the reflectance changed from 78% to 43%, and data could not be satisfactorily played back. FIG. 9 shows the reflectance and jitter changes upon continuously irradiating this disc with light. When the irradiation power is equal to or higher than 5 mW, the jitter and reflectance start being improved. When the irradiation power is equal to or larger than 5.5 mW, the jitter and reflectance return to the characteristics before deterioration. It is supposed that such playback signal recovery phenomenon is caused by selective crystallization of those portions of the playback signal enhancement layer which correspond to a non-pit portion. Note that in the disc continuously irradiated with light before the acceleration test, the jitter was equal to or lower than 6%, and the reflectance of the non-recording portion was equal to or higher than 80%. In this case, data could be played back even after the acceleration test for 400 hrs.

A comparative example will be described to explain the invention in more detail.

Three types of discs A, B, and C were formed, each of which had the same layer structure as that in the fourth embodiment, and included an optical interference layer 34 with a thickness of 0, 10, or 30 nm. In the completely formed optical disc, initial crystallization for only the recording layer was tried by the laser initialization apparatus. However, in the disc A, the playback signal enhancement layer was also initialized at the same time.

Under the evaluation condition shown in FIG. 12, random data was recorded on this rewritable optical disc with a recording power of 11 mW and an erasure power of 5 mW. After that, an acceleration test was performed under the conditions of a temperature of 85° C. and a relative humidity of 85%. Light was continuously applied to the three types of discs from which data could not be played back after the acceleration test for 300 hrs. FIG. 10 or 11 shows the laser power dependence of the jitter and the normalized reflectance of a non-recording portion. In the disc B or C, when the continuous irradiation power is equal to or higher than 5.5 mW, the reflectance increases to improve the jitter. On the other hand, in the disc A, the reflectance does not change when the irradiation power is equal to or higher than 5.5 mW, but the jitter increases when the irradiation power is equal to or higher than 4 mW. As described above, data can be played back from the disc B or C in which the recording layer is separated from the playback signal enhancement layer, upon continuously irradiating the disc with light even after the acceleration degradation. However, in the disc A in which the recording layer is in contact with the playback signal enhancement layer, the signal cannot be recovered even by continuously irradiating the disc with light after the acceleration test.

The effect of the invention has been verified according to the fourth, fifth, and sixth embodiments and the comparative example, and the effect of the invention does not degrade depending on the light source wavelength and optical system of the recording/playback apparatus. For example, in a system under having a light source wavelength of 405 nm and an NA of an objective lens of 0.65 or 0.85 for a next-generation optical disc, the same effect as that in the fourth, fifth, and sixth embodiments can be obtained by optimizing the thickness of each layer in the medium.

The optical recording mediums according to the above-described embodiments will be summarized below.

Each of the rewritable optical recording medium and the WO optical recording medium has a recording layer which stores information by light irradiation, and a playback signal enhancement layer which enhances a playback signal obtained from the recording layer. Hence, the playback signal enhancement layer can emphasize the playback signal to stably play back the data even when information (recording mark) recorded on the recording layer deteriorates with time.

The read-only optical recording medium has a playback signal enhancement layer which enhances a playback signal. Hence, the playback signal enhancement layer can emphasize a playback signal to stably play back data even when recorded information (pit) deteriorates with time.

According to the first embodiment of the invention, the rewritable optical recording medium includes an interference layer, recording layer, playback signal enhancement layer, and reflecting layer which are stacked on a substrate. The interference layer is required to separate the recording layer from the playback signal enhancement layer and optically amplify the playback signal, and contains at least one material selected from the group consisting of ZnS, SiO₂, SiO, Al₂O₃, TiO₂, ZrO₂, ZnO, HfO₂, Ta₂O₅, Si₃N₄, and AlN. The recording layer is made of a material which reversibly transits, upon being irradiated with the light beam, between a crystalline state and amorphous state each having different optical characteristics. For example, a ternary material such as Ge—Sb—Te, Ge—Bi—Te, or In—Sb—Te is used. Also, a trace amount of at least one member selected from the group consisting of Co, Pt, Pd, Au, Ag, Ir, Nb, Ta, V, W, Ti, Cr, Zr, Bi, Sn, and Sb may be doped in the ternary material to obtain good characteristics as the recording layer. The playback signal enhancement layer is made of a ternary material such as Ge—Sb—Te, Ge—Bi—Te, or In—Sb—Te, and a material obtained by doping a trace amount of at least one member selected from the group consisting of Co, Pt, Pd, Au, Ag, Ir, Nb, Ta, V, W, Ti, Cr, Zr, Bi, Sn, and Sb in the ternary material. In this case, the crystallization temperature of the playback signal enhancement layer is higher than that of the recording layer. The reflecting layer comprises an alloy material containing Ag, Al, Au, or Cu as a principal component.

The rewritable optical recording medium formed by combining the above-described layers according to the first embodiment of the invention can record information after crystallizing the recording layer by an initialization process. In this case, the condition is optimized such that the temperature of a laser light focused portion becomes equal to or higher than the crystallization temperature of the recording layer, and equal to or lower than the crystallization temperature of the playback signal enhancement layer, and accordingly, the disc is initialized. The signal is recorded using a multipulse by the same method of the recordable CD and DVD. The difference between the reflectances of the recording and non-recording portions is detected to play back data. Furthermore, the playback method of compensating for deterioration of the playback signal after storage in the disc for a long time will be described below. The difference between the reflectances of the recording and non-recording portions becomes small by the recrystallization and defect of the recording mark after storage in the disc for a long time. Accordingly, data is hardly played back. In such case, when the medium is continuously irradiated with light with a constant power, the playback signal enhancement layer selectively crystallizes corresponding to the recording and non-recording portions in the recording layer. As a result, the playback signal is amplified. The same effect can also be obtained when the medium is continuously irradiated with light immediately after recording. For example, when the reflectance in a crystalline state is higher than that in the amorphous state (i.e., High to Low (to be referred to as HtoL hereinafter) polarity), only part of the playback signal enhancement layer corresponding to the crystallized portion (non-recording portion) in the recording layer crystallizes by continuous irradiation. Upon irradiating this medium with the playback light, the reflectance of the non-recording portion increases, and the difference between the reflectances of the recording and non-recording portions becomes large. Hence, data can be stably played back even after storage in the disc for a long time. When the reflectance in the crystalline state is lower than that in the amorphous state (i.e., Low to High (to be referred to as LtoH hereinafter) polarity), only part of the playback signal enhancement layer corresponding to the amorphous recording mark in the recording layer crystallizes by continuous irradiation. Upon irradiating this medium with the playback light, the reflectance of the recording mark increases, and the difference between the reflectances of the recording and non-recording portions becomes large. Accordingly, data can be stably played back even after storage in the disc for a long time.

According to the second embodiment of the invention, the WO optical recording medium includes an interference layer, recording layer, playback signal enhancement layer, and reflecting layer which are stacked on a substrate. The interference layer is required to separate the recording layer from the playback signal enhancement layer and optically amplify the playback signal, and contains at least one material selected from the group consisting of ZnS, SiO₂, SiO, Al₂O₃, TiO₂, ZrO₂, ZnO, HfO₂, Ta₂O₅, Si₃N₄, and AlN. The recording layer is made of an inorganic material such as a chalcogenide element represented by a Te compound, or a recording material obtained by dispersing a pigment such as a cyanine derivative, phthalocyanine derivative, porphyrin derivative, or metal porphyrin derivative in a solvent. The playback signal enhancement layer is made of a ternary material such as Ge—Sb—Te, Ge—Bi—Te, or In—Sb—Te, and a trace amount of at least one member selected from the group consisting of Co, Pt, Pd, Au, Ag, Ir, Nb, Ta, V, W, Ti, Cr, Zr, Bi, Sn, and Sb doped in the ternary material. The reflecting layer comprises an alloy material containing Ag, Al, Au, and Cu as a principal component.

In the WO optical recording medium formed by combining the above-described layers according to the second embodiment of the invention, a recording mark is formed by transforming or chemically changing part of the recording layer upon irradiation of a recording beam. When the recording mark is irradiated with playback light, the reflectance of the recording portion becomes different from that of the non-recording portion, thereby playing back data. Next, the playback method of compensating for deterioration of the playback signal after storage in the disc for a long time will be described below. The difference between the reflectances of the recording and non-recording portions becomes small by the chemical change and defect of the recording mark after storage in the disc or exposing the disc to natural light for a long time. Accordingly, data is hardly played back. For example, when the reflectance of the non-recording portion is higher than that of the recording portion (i.e., HtoL polarity), only part of the playback signal enhancement layer corresponding to the non-recording portion in the recording layer crystallizes by continuous irradiation with a constant power. Upon irradiating this medium with the playback light, the reflectance of the non-recording portion increases, and the difference between the reflectances of the recording and non-recording portions becomes large. Hence, data can be stably played back even after storage in the disc for a long time. When the reflectance of the non-recording portion is lower than that of the recording portion (i.e., LtoH polarity), only part of the playback signal enhancement layer corresponding to the recording portion in the recording layer crystallizes by continuous irradiation with a constant power. Upon irradiating this medium with the playback light, the reflectance of the recording portion increases, and the difference between the reflectances of the recording and non-recording portions becomes large. Accordingly, data can be stably played back even after storage in the disc for a long time. The same effect can be obtained by continuous irradiation immediately after recording.

Furthermore, this technique can be applied to a read-only optical disc according to the third embodiment of the invention. When the playback signal enhancement layer made of a phase change material is inserted between a resin substrate and a metal reflecting layer in a general read-only disc, the playback signal of the disc which deteriorates with time can be recovered. The resin substrate used for the read-only optical disc has pits having a depth λ/(4n) a light source wavelength λ. Reference symbol n denotes the refractive index of the resin substrate. When irradiating such disc with the playback light, the reflected light whose phase shifts depending on the presence/absence of the pit returns to play back information by using the phase difference. However, in the disc having a defect by deterioration with time, it is difficult to detect the phase difference. To cope with this problem, the light is continuously applied to the read-only optical disc having the playback signal enhancement layer. As a result, since part of the playback signal enhancement layer corresponding to the non-pit portion crystallizes, the optical contrast depending on the presence/absence of the pit can be enhanced. According to this effect, without any problems, data can be played back from the read-only optical disc which deteriorates with time.

Recorded information which cannot be played back after deterioration with time can be recovered and played back from the above-described optical disc.

According to the embodiment of the invention, a medium processing apparatus which processes the above-described rewritable optical recording medium, WO optical recording medium, and read-only optical recording medium will be described below. As described above, in the recording layer of the rewritable optical recording medium or WO optical recording medium, a recording mark is formed in a region irradiated with a pulse laser with the first laser power and the second laser power larger than the first laser power. The medium processing apparatus to be described below irradiates the light incident surface of the rewritable optical recording medium or WO optical recording medium with the pulse laser beam with the first laser power and the second laser power larger than the first laser power to record information on the recording layer (form a recording mark). Additionally, the medium processing apparatus continuously irradiates the light incident surface of the rewritable optical recording medium or WO optical recording medium with the light beam with the third laser power larger than the first laser power and smaller than the second laser power, to change the state of the first region on the playback signal enhancement layer opposite to the non-recording mark region in the recording layer. As a result, the reflectance of the first region becomes different from that of the second region on the playback signal enhancement layer opposite to the recording region in the recording layer.

This medium processing apparatus continuously irradiates the light incident surface of the read-only recording medium with the light beam with a predetermined laser power to change the state of the first region opposite to the non-pit region. As a result, the reflectance of the first region becomes different from that of the second region opposite to the pit region.

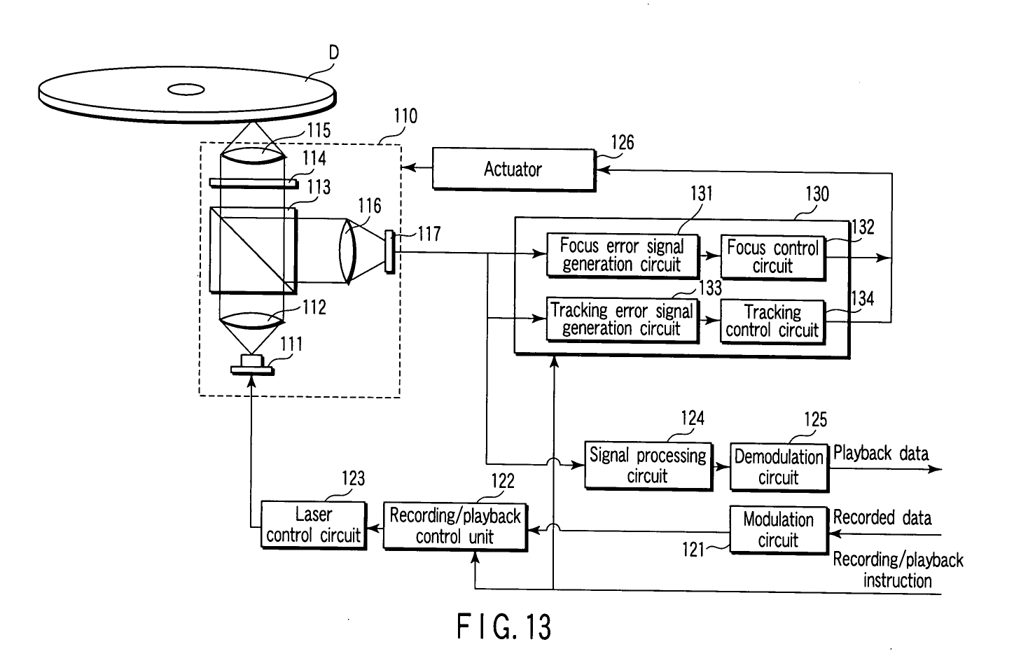

Referring to FIG. 13, an information recording/playback apparatus which irradiates the above-described optical recording medium (information storage medium) with the laser beam, records the information on these optical recording mediums, plays back the information recorded on the optical recording mediums, and emphasizes the playback signal obtained from these optical recording mediums will be described below. FIG. 13 is a block diagram showing a schematic arrangement of the optical disc apparatus (medium processing apparatus).

As shown in FIG. 13, the optical disc apparatus includes an optical pickup 110, modulation circuit 121, recording/playback control unit 122, laser control circuit 123, signal processing circuit 124, demodulation circuit 125, actuator 126, and focus tracking control unit 130.

The optical pickup 110 also includes a laser 111, collimator lens 112, polarization beam splitter (to be referred to as a PBS hereinafter) 113, quarter wavelength plate 114, objective lens 115, focus lens 116, and photodetector 117.

The focus tracking control unit 130 also includes a focus error signal generation circuit 131, focus control circuit 132, tracking error signal generation circuit 133, and tracking control circuit 134.

The operation of recording the information on an optical disc in this optical disc apparatus will be described below. The modulation circuit 121 modulates recorded information (data symbol) from a host in accordance with a predetermined modulation method into a channel bit sequence. The channel bit sequence corresponding to the recorded information is input to the recording/playback control unit 122. Also, a recording/playback instruction (in this case, recording instruction) is output from the host to the recording/playback control unit 122. The recording/playback control unit 122 outputs a control signal to the actuator 126, and drives an optical pickup such that the light beam is appropriately focused on a target recording position. The recording/playback control unit 122 also supplies the channel bit sequence to the laser control circuit 123. The laser control circuit 123 converts the channel bit sequence into a laser driving waveform, and drives the laser 111. That is, the laser control circuit 123 pulse-drives the laser 111. In accordance with this operation, the laser 111 emits the recording light beam (pulse laser) corresponding to the desired bit sequence. For example, the rewritable optical recording medium is irradiated with a pulse laser beam with the first laser power (e.g., 4 or 5 mW) and the second laser power (e.g., 10 mW) larger than the first laser power. The WO optical recording medium is irradiated with the pulse laser beam with the first laser power (e.g., 0.5 mW) and the second laser power (e.g., 10 mW) larger than the first laser power.

The recording light beam emitted from the laser 111 becomes parallel light by the collimator lens 112, and enters and passes through the PBS 113. The beam passing through the PBS 113 then passes through the quarter wavelength plate 114, and is focused on the information recording surface of the optical disc by the objective lens 115. The focused recording light beam is maintained in an optimal microspot on the recording surface (recording layer 4 or 13) by focus control performed by the focus control circuit 132 and actuator 126, and the tracking control performed by the tracking control circuit 134 and actuator 126.

Subsequently, the emphasizing process of a playback signal obtained from the optical disc in the optical disc apparatus will be described below. Basically, the emphasizing process is the same as the above-described data recording process, except an irradiation scheme and laser power.

For example, the rewritable optical recording medium is continuously irradiated with the light beam with the third laser power (e.g., 5 or 6 mW) larger than the first laser power (e.g., 4 or 5 mW) and smaller than the second laser power (e.g., 10 mW). Hence, as described with reference to FIG. 1, the region 6a opposite to the non-recording mark region in the recording layer 4 changes (phase change), and the reflectance of the region 6a becomes different from that of the region 6b opposite to the region of the amorphous recording mark 4a in the recording layer 4. That is, the reflectances of the regions 6a and 6b are different from each other.

The WO optical recording medium is continuously irradiated with the light beam with the third laser power (e.g., 1 mW) larger than the first laser power (e.g., 0.5 mW) and smaller than the second laser power (e.g., 10 mW). Hence, as described with reference to FIG. 2, a region 15a opposite to the non-recording mark region in the recording layer 13 changes (phase change), and the reflectance of the 15a becomes different from that of a region 15b opposite to the region of the recording mark 13a in the recording layer 13. That is, the reflectances of the regions 15a and 15b are different from each other.

The read-only optical recording medium is continuously irradiated with the light beam with a predetermined laser power. Hence, as described with reference to FIG. 3, a region 23a opposite to the non-pit region changes, and the reflectance of the region 23a becomes different from that of a region 23b opposite to the pit region. That is, the reflectances of the regions 23a and 23b are different from each other.

The operation of playing back the data from the optical disc in this optical disc apparatus will be described below. A recording/playback instruction (in this case, playback instruction) is output from the host to the recording/playback control unit 122. The recording/playback control unit 122 outputs a playback control signal to the laser control circuit 123 in accordance with the playback instruction from the host. The laser control circuit 123 drives the laser 111 based on the playback control signal. In accordance with this operation, the laser 111 applies the playback light beam.

The playback light beam applied from the laser 111 becomes parallel light by the collimator lens 112, and enters and passes through the PBS 113. The light beam passing through the PBS 113 then passes through the quarter wavelength plate 114, and is focused on the information recording surface of the optical disc by the objective lens 115. The focused playback light beam is maintained in an optimal microspot on the recording surface by focus control performed by the focus control circuit 132 and actuator 126, and the tracking control performed by the tracking control circuit 134 and actuator 126. In this case, the playback light beam applied on the optical disc is reflected by the reflecting layer. Additionally, the recording mark or pit component in the reflected light (playback signal) is emphasized. Reflected light passes through the objective lens 115 in the opposite direction, and becomes the parallel light again. The reflected light then passes through the quarter wavelength plate 114, has vertical polarization with respect to incident light, and is reflected by the PBS 113. The beam reflected by the PBS 113 becomes convergent light by the focus lens 116, and enters the photodetector 117. The photodetector 117 has, e.g., four photodetectors. The light beam which becomes incident on the photodetector 117 is photoelectrically converted into an electrical signal and amplified. The amplified signal is equalized and binarized by the signal processing circuit 124 and sent to the demodulation circuit 125. The demodulation circuit 125 executes a demodulation operation corresponding to a predetermined modulation method and outputs playback data.

Based on part of the electrical signal output from the photodetector 117, the focus error signal generation circuit 131 generates a focus error signal. Similarly, based on part of the electrical signal output from the photodetector 117, the tracking error signal generation circuit 133 generates a tracking error signal. The focus control circuit 132 controls the actuator 128 and the focus of the beam spot, based on the focus error signal. The tracking control circuit 134 controls the actuator 128 and the tracking of the beam spot, based on the tracking error signal.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage medium comprising:
a light incident surface from which a recording/playback light beam enters;
a reflecting layer which reflects the light beam entering from the light incident surface;
a recording layer which is arranged between the light incident surface and the reflecting layer; and
a playback signal emphasizing layer which is arranged between the recording layer and the reflecting layer, and used to emphasize a playback signal containing a reflectance change component generated by a recording mark formed on the recording layer,
wherein in the recording layer, a recording mark is formed in a region irradiated with a pulse laser beam with a first laser power and a second laser power larger than the first laser power from the light incident surface, and
when the playback signal emphasizing layer is continuously irradiated with the light beam with a third laser power larger than the first laser power and smaller than the second laser power from the light incident surface, a first region in the playback signal emphasizing layer opposite to a non-recording mark region in the recording layer changes, and a reflectance of the first region becomes different from a reflectance of a second region in the playback signal emphasizing layer opposite to a recording mark region in the recording layer.

2. An information storage medium comprising:
a light incident surface from which a playback light beam enters;
a reflecting layer which changes a reflectance of the entered light beam by a preformed pit; and
a playback signal emphasizing layer which is arranged between the light incident surface and the reflecting layer, and used to emphasize a playback signal containing a reflectance change component generated by the pit,
wherein when the playback signal emphasizing layer is continuously irradiated with the light beam with a predetermined laser power from the light incident surface, a first region in the playback signal emphasizing layer opposite to a non-pit region changes, and a reflectance of the first region becomes different from a reflectance of a second region in the playback signal emphasizing layer opposite to a pit region.

3. A medium according to claim 1, further comprising an optical interference layer arranged between the recording layer and the playback signal emphasizing layer.

4. A medium according to claim 1, wherein the playback signal emphasizing layer contains at least one material selected from the group consisting of Ge, Sb, Te, Bi, Sn, In, and Ag.

5. A medium according to claim 2, wherein the playback signal emphasizing layer contains at least one material selected from the group consisting of Ge, Sb, Te, Bi, Sn, In, and Ag.

6. A medium according to claim 1, wherein the first laser power is 4 mW, the second laser power is 10 mW, and the third laser power is 5 mW.

7. A medium according to claim 1, wherein the first laser power is 0.5 mW, the second laser power is 10 mW, and the third laser power is 1 mW.

8. A medium processing apparatus for processing an information storage medium which includes a light incident surface from which a recording/playback light beam enters, a reflecting layer which reflects the light beam entering from the light incident surface, a recording layer which is arranged between the light incident surface and the reflecting layer, and a playback signal emphasizing layer which is arranged between the recording layer and the reflecting layer, and used to emphasize a playback signal containing a reflectance change component generated by a recording mark formed on the recording layer, wherein in the recording layer, a recording mark is formed in a region irradiated with a pulse laser beam with a first laser power and a second laser power larger than the first laser power from the light incident surface, and when the playback signal emphasizing layer is continuously irradiated with the light beam with a third laser power larger than the first laser power and smaller than the second laser power from the light incident surface, a first region in the playback signal emphasizing layer opposite to a non-recording mark region in the recording layer changes, and a reflectance of the first region becomes different from a reflectance of a second region in the playback signal emphasizing layer opposite to a recording mark region in the recording layer, comprising:
an irradiation unit configured to irradiate the light incident surface with the light beam; and
a control unit configured to control to continuously apply the light beam with the third laser power.

9. An apparatus according to claim 8, wherein the first laser power is 4 mW, the second laser power is 10 mW, and the third laser power is 5 mW.

10. An apparatus according to claim 8, wherein the first laser power is 0.5 mW, the second laser power is 10 mW, and the third laser power is 1 mW.

11. A medium processing method for processing an information storage medium which includes a light incident surface from which a recording/playback light beam enters, a reflecting layer which reflects the light beam entering from the light incident surface, a recording layer which is arranged between the light incident surface and the reflecting layer, and a playback signal emphasizing layer which is arranged between the recording layer and the reflecting layer, and used to emphasize a playback signal containing a reflectance change component generated by a recording mark formed on the recording layer, wherein in the recording layer, a recording mark is formed in a region irradiated with a pulse laser beam with a first laser power and a second laser power larger than the first laser power from the light incident surface, and when the playback signal emphasizing layer is continuously irradiated with the light beam with a third laser power larger than the first laser power and smaller than the second laser power from the light incident surface, a first region in the playback signal emphasizing layer opposite to a non-recording mark region in the recording layer changes, and a reflectance of the first region becomes different from a reflectance of a second region in the playback signal emphasizing layer opposite to a recording mark region in the recording layer, comprising:
continuously irradiating the light incident surface with the light beam with the third laser power.

12. A method according to claim 11, wherein the first laser power is 4 mW, the second laser power is 10 mW, and the third laser power is 5 mW.

13. A method according to claim 11, wherein the first laser power is 0.5 mW, the second laser power is 10 mW, and the third laser power is 1 mW.
